(19) United States
(12) Patent Application Publication
(10) Pub. No.: US 2025/0323327 A1
(43) Pub. Date: Oct. 16, 2025

(54) CIRCUIT FOR BATTERY MANAGEMENT SYSTEM (BMS) AND BATTERY SYSTEM

(71) Applicant: EVE ENERGY CO., LTD., HUIZHOU (CN)

(72) Inventors: HONGWEI PENG, HUIZHOU (CN); GENG PENG, HUIZHOU (CN); QIANG HONG, HUIZHOU (CN)

(21) Appl. No.: 18/934,254

(22) Filed: Nov. 1, 2024

Related U.S. Application Data
(63) Continuation of application No. PCT/CN2024/097829, filed on Jun. 6, 2024.

(30) Foreign Application Priority Data
Apr. 15, 2024 (CN) 202420783199.9

(51) Int. Cl. H01M 10/42; H01M 10/48; H02J 7/00

(52) U.S. Cl. CPC H01M 10/425; H01M 10/486; H02J 7/0016; H02J 7/0063; H01M 2010/4271

(57) ABSTRACT

A circuit for battery management system (BMS) and a battery system are disclosed. The circuit includes: a processing chip configured for controlling the auxiliary driver to amplify a driving current in response to the battery pack requiring being charged; a charging driver configured for conducting a charging path between the battery connection interface and the external connection interface to charge the battery pack, under driving of the amplified driving current; the processing chip is further configured for controlling the discharging driver to conduct a discharging path between the battery connection interface and the external connection interface, in response to the battery pack requiring being discharged.

### CROSS-REFERENCE TO RELATED APPLICATIONS

This application is a continuation-application of International (PCT) Patent Application No. PCT/CN2024/097829 filed Jun. 6, 2024, which claims priority to Chinese Patent Application No. 202420783199.9, filed on Apr. 15, 2024, the content of which is herein incorporated by reference in its entirety.

### TECHNICAL FIELD

The present disclosure generally relates to the technical field of battery, and in particular to a circuit for battery management system (BMS) and a battery system.

### BACKGROUND

Battery Management System (BMS) is also known as battery nanny or battery housekeeper. The BMS can realize intelligent management and maintenance of each battery unit, prevent overcharging and over-discharging of the battery, prolong the service life of the battery, and monitor the status of the battery.

In the related art, the BMS has poor charging and discharging management reliability, poor anti-interference capability, a complex circuit structure, and high hardware cost.

### SUMMARY

On a first aspect, a circuit for battery management system (BMS) is provided, including: a processing chip; a battery connection interface, connected to the processing chip and a battery pack; an external connection interface, connected to an external device; a discharging driver, connected to the processing chip, the external connection interface, and the battery connection interface; an auxiliary driver, connected to the processing chip and the external connection interface; and a charging driver, connected to the auxiliary driver, the external connection interface, and the battery connection interface; wherein the processing chip is configured for controlling the auxiliary driver to amplify a driving current and transmit an amplified driving current to the charging driver, in response to the battery pack requiring being charged; the charging driver is configured for conducting a charging path between the battery connection interface and the external connection interface to charge the battery pack, under driving of the amplified driving current; the processing chip is further configured for controlling the discharging driver to conduct a discharging path between the battery connection interface and the external connection interface to discharge the external device, in response to the battery pack requiring being discharged.

On a second aspect, a battery system is provided, including a battery pack and the circuit for battery management system (BMS) in the first aspect.

On a third aspect, another circuit for battery management system (BMS) is provided, including: a processing chip; a battery connection interface, connected to the processing chip and a battery pack; an external connection interface, connected to an external device; a discharging driver, connected to between the external connection interface and the battery connection interface and further connected to the processing chip; a charging driver, connected to between the external connection interface and the battery connection interface; and an auxiliary driver, connected to the charging driver and the processing chip; and wherein the processing chip is configured for outputting a first level signal to control the discharging driver to be conducted such that a discharging path between external connection interface and the battery connection interface is conducted, in response to the battery pack being discharged, and the processing chip is further configured for outputting a second level signal to control the auxiliary driver and charging driver to be conducted such that a charging path between external connection interface and the battery connection interface is conducted, in response to the battery pack being charged.

### BRIEF DESCRIPTION OF THE DRAWINGS

FIG. 1 is a first schematic diagram of a circuit for battery management system according to some embodiments of the present disclosure;

FIG. 2 is a second schematic diagram of a circuit for battery management system according to some embodiments of the present disclosure;

FIG. 3 is a third schematic diagram of a circuit for battery management system according to some embodiments of the present disclosure;

FIG. 4 is a fourth schematic diagram of a circuit for battery management system according to some embodiments of the present disclosure;

FIG. 5 is a fifth schematic diagram of a circuit for battery management system according to some embodiments of the present disclosure;

FIG. 6 is a sixth schematic diagram of a circuit for battery management system according to some embodiments of the present disclosure.

### MARKING IN THE DRAWINGS

100, processing chip; 200, battery connection interface; 210, total negative port; 220, cell connection port; 300, external connection interface; 310, first connection port; 400, discharging driver; 410, discharging sub-driver; 500, auxiliary driver; 600, charging driver; 610, charging sub-driver; 700, voltage equalizer; 810, current detector; 820, temperature detector; 830, communication connector; 840, charging detector; 850, discharging detector; G1, first triode; G2, second triode; G3, third triode; R1, first resistor; R2, second resistor; R3, third resistor; R4, fourth resistor; R5, fifth resistor; R6, sixth resistor; R7, seventh resistor; R8, eighth resistor; R9, ninth resistor; D1, first diode; D2, second diode; D3, third diode; G11, first switching tube; G12, second switching tube; C1, first capacitance; C2, second capacitance.

### DETAILED DESCRIPTION

A circuit for battery management system (BMS) is provided, including: a processing chip; a battery connection interface, connected to the processing chip and a battery pack; an external connection interface, connected to an external device; a discharging driver, connected to the processing chip, the external connection interface, and the battery connection interface; an auxiliary driver, connected to the processing chip and the external connection interface; and a charging driver, connected to the auxiliary driver, the external connection interface, and the battery connection interface; wherein the processing chip is configured for controlling the auxiliary driver to amplify a driving current and transmit an amplified driving current to the charging driver, in response to the battery pack requiring being charged; the charging driver is configured for conducting a charging path between the battery connection interface and the external connection interface to charge the battery pack, under driving of the amplified driving current; the processing chip is further configured for controlling the discharging driver to conduct a discharging path between the battery connection interface and the external connection interface to discharge the external device, in response to the battery pack requiring being discharged.

In some embodiments, the processing chip includes: a discharging control pin, connected to the discharging driver and configured for outputting a first level signal to control the discharging driver to be conducted; and and a charging control pin, connected to the auxiliary driver and configured for outputting a second level signal to the auxiliary driver, the second level signal being the driving current.

In some embodiments, the auxiliary driver includes: a two-stage triode, configured for amplifying the second level signal and generate the amplified driving current.

In some embodiments, the two-stage triode includes a first triode and a second triode; the auxiliary driver further includes a first resistor, a second resistor, and a first diode; wherein an anode of the first diode is connected to the charging control pin, a cathode of the first diode is connected to an emitter of the first triode and the charging driver, respectively, a collector of the first triode is connected to a first end of the first resistor, a base of the first triode is connected to an emitter of the second triode, a collector of the second triode is connected to the external connection interface, a base of the second triode is connected to a first end of the second resistor and the anode of the first diode respectively, and a second end of the first resistor and a second end of the second resistor are connected to the external connection interface, respectively.

In some embodiments, the charging driver includes a plurality of charging sub-drivers, and each of the charging sub-drivers includes a first switching tube, configured for being conducted under the amplified driving current.

In some embodiments, the each of the charging sub-drivers further includes a third resistor; the battery connection interface includes a total negative port, and the external connection interface includes a first connection port; wherein a first end of the third resistor is connected to the auxiliary driver, a second end of the third resistor is connected to a gate of the first switching tube, a drain of the first switching tube is connected to the total negative port, and a source of the first switching tube is connected to the first connection port.

In some embodiments, the discharging driver includes a plurality of discharging sub-drivers, and each of the discharging sub-drivers includes a second switching tube, configured for being conducted under the first level signal.

In some embodiments, the each of the discharging sub-drivers further includes a fourth resistor; the battery connection interface includes a total negative port; wherein a first end of the fourth resistor is connected to the discharging control pin, a second end of the fourth resistor is connected to a gate of the second switching tube, a source of the second switching tube is connected to the total negative port, and a drain of the second switching tube is connected to the charging driver.

In some embodiments, the battery connection interface includes a total negative port, the external connection interface includes a first connection port, and the charging driver includes a plurality of charging sub-drivers; control ends of the charging sub-drivers are connected to the auxiliary driver, and the charging sub-drivers are connected in parallel between the total negative port and the first connection port.

In some embodiments, the discharging driver includes a plurality of discharging sub-drivers, and control ends of the discharging sub-drivers are connected to the discharging control pin; the discharging sub-drivers are connected in parallel between the total negative port and the charging sub-drivers.

In some embodiments, the circuit for BMS further includes a plurality of voltage equalizers; wherein the processing chip includes a group of battery pins, the group of battery pins includes a plurality of battery pins, and the battery connection interface includes a plurality of cell connection ports; first ends of the voltage equalizers are connected to the battery pins in one-to-one correspondence, and second ends of the voltage equalizers are connected to the cell connection ports in one-to-one correspondence.

In some embodiments, each of the voltage equalizers includes a third triode, a fifth resistor, a sixth resistor, a seventh resistor, an eighth resistor, a first capacitance, and a second capacitance; a collector of the third triode is connected to a first end of the fifth resistor, an emitter of the third triode is connected to a cell connection port corresponding to a negative pole of a same single cell, and a base of the third triode is connected to a first end of the sixth resistor; a second end of the sixth resistor is connected to a second end of the seventh resistor, the second end of the seventh resistor is further connected to a battery pin corresponding to the negative pole of the same single cell, and a first end of the seventh resistor is connected to the emitter of the third triode; a second end of the fifth resistor is connected to a cell connection port corresponding to the positive pole of the same single cell, a first end of the eighth resistor is connected to the second end of the fifth resistor, and a second end of the eighth resistor is connected to a battery pin corresponding to the positive pole of the same single cell; the first capacitor is connected between the second end of the eighth resistor and the second end of the seventh resistor; the second capacitor is connected between the second end of the seventh resistor and a ground.

In some embodiments, the circuit for BMS further includes a second diode, a third diode, and a ninth resistor; wherein a first end of the ninth resistor is connected to a cell connection port corresponding to a negative pole of a first single cell, and a second end of the ninth resistor is connected to the total negative port, wherein the first single cell is a single cell adjacent to and connected to the total negative port; a cathode of the second diode is connected to a battery pin corresponding to the negative pole of the first single cell, and an anode of the second diode is connected to the total negative port; a cathode of the third diode is connected to a battery pin corresponding to a positive pole of the first single cell, and an anode of the third diode is connected to the total negative port.

In some embodiments, the circuit for BMS further includes a current detector and a temperature detector; wherein the processing chip further includes temperature detection pins and current detection pins; the temperature detection pins are connected to the temperature detector, and the temperature detector is configured for being connected to a temperature sensing probe; the battery detection pins are connected to the current detector, and the current detector is connected between the external connection interface and the battery connection interface.

In some embodiments, the circuit for BMS further includes a communication connector; wherein the processing chip further includes communication pins; the communication pins are connected to the communication connector, and the communication connector is configured for plugging in a terminal device.

In some embodiments, the circuit for BMS further includes a charging detector and a discharging detector; wherein the processing chip further includes a charging detection pin and a discharge detection pin; the charging detection pin is connected to the charging detector, and the charging detector is further connected to the charging driver; the discharge detection pin is connected to the discharging detector, and the discharging detector is further connected to the discharging driver.

A battery system is provided, including a battery pack; and a circuit for battery management system (BMS), including: a processing chip; a battery connection interface, connected to the processing chip and the battery pack; an external connection interface, connected to an external device; a discharging driver, connected to the processing chip, the external connection interface, and the battery connection interface; an auxiliary driver, connected to the processing chip and the external connection interface; and a charging driver, connected to the auxiliary driver, the external connection interface, and the battery connection interface; wherein the processing chip is configured for controlling the auxiliary driver to amplify a driving current and transmit an amplified driving current to the charging driver, in response to the battery pack requiring being charged; the charging driver is configured for conducting a charging path between the battery connection interface and the external connection interface to charge the battery pack, under driving of the amplified driving current; the processing chip is further configured for controlling the discharging driver to conduct a discharging path between the battery connection interface and the external connection interface to discharge the external device, in response to the battery pack requiring being discharged.

A circuit for battery management system (BMS) is provided, including: a processing chip; a battery connection interface, connected to the processing chip and a battery pack; an external connection interface, connected to an external device; a discharging driver, connected to between the external connection interface and the battery connection interface and further connected to the processing chip; a charging driver, connected to between the external connection interface and the battery connection interface; and an auxiliary driver, connected to the charging driver and the processing chip; and wherein the processing chip is configured for outputting a first level signal to control the discharging driver to be conducted such that a discharging path between external connection interface and the battery connection interface is conducted, in response to the battery pack being discharged, and the processing chip is further configured for outputting a second level signal to control the auxiliary driver and charging driver to be conducted such that a charging path between external connection interface and the battery connection interface is conducted, in response to the battery pack being charged.

In some embodiments, the auxiliary driver includes a first triode and a second triode, a first resistor, a second resistor, and a first diode; wherein an anode of the first diode is connected to the charging control pin, a cathode of the first diode is connected to an emitter of the first triode and the charging driver, respectively, a collector of the first triode is connected to a first end of the first resistor, a base of the first triode is connected to an emitter of the second triode, a collector of the second triode is connected to the external connection interface, a base of the second triode is connected to a first end of the second resistor and the anode of the first diode respectively, and a second end of the first resistor and a second end of the second resistor are connected to the external connection interface, respectively.

In some embodiments, the charging driver includes a first switching tube, configured for being conducted in response to the auxiliary driver being conducted under the second level signal; the discharging driver includes a second switching tube, configured for being conducted under the first level signal.

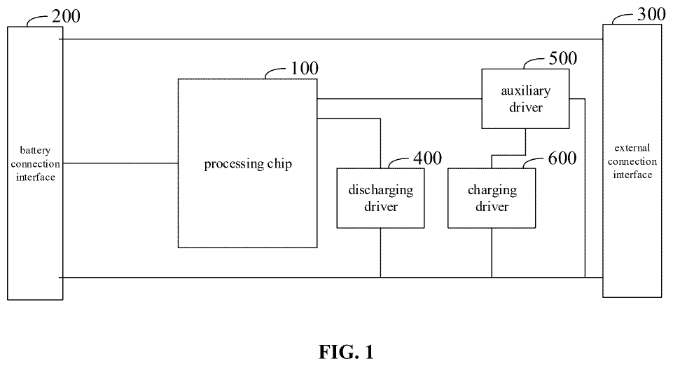

In some embodiments, as shown in FIG. 1, a circuit for battery management system (BMS) is provided, including a processing chip 100, a battery connection interface 200, an external connection interface 300, a discharging driver 400, an auxiliary driver 500, and a charging driver 600. The processing chip 100 includes a group of battery pins, a discharging control pin, and a charging control pin. The battery connection interface 200 is connected to the group of battery pins, and the battery connection interface 200 is used to be connected to a battery pack, and the battery pack includes a plurality of single (individual) cells which are series-connected. The external connection interface 300 is used to be connected to an external device. The discharging driver 400 is connected to the discharging control pin. The discharging driver 400 is connected to between the external connection interface 300 and the battery connection interface 200. The auxiliary driver 500 is connected to the charging control pin and the external connection interface 300, respectively. The charging driver 600 is connected to the auxiliary driver 500. The charging driver 600 is connected between the external connection interface 300 and the battery connection interface 200.

The processing chip 100 is a battery management chip, and the processing chip 100 has functions such as battery charging management and battery discharging management. Exemplarily, the processing chip 100 may be a SH3676016B model chip.

The processing chip 100 may include the group of battery pins, the group of battery pins is used to be connected to a battery pack provided at the battery connection interface 200, and the group of battery pins may include a plurality of battery pins. The battery pack may include a plurality of single cells connected in series, and each battery pin is connected to a respective single cell in one-to-one correspondence. Exemplarily, the number of battery pins may be 17 (e.g., pins VC0 to VC16). The processing chip 100 also includes a discharging control pin and a charging control pin. The discharging control pin can be used to output a first level signal, which is used to drive the discharging driver 400 to be conducted to operate. The charging control pin can be used to output a second level signal, which is used to drive the auxiliary driver 500 to be conducted to operate.

The group of battery pins may be connected to the battery connection interface 200 by means of plugging or welding, etc., so that the group of battery pins is electrically connected to the battery connection interface 200. The battery pack may be connected to the battery connection interface 200 by plugging, and the battery pack is electrically connected to the battery connection interface 200. That is, the battery pack is electrically connected to the group of battery pins of the processing chip 100. Exemplarily, the battery pack may include 6 to 16 single cells connected in series.

In some embodiments, the external device includes a load or charging device.

The external connection interface 300 can be used for a load to be plugged, and thus, the battery pack can discharge the load when a discharging path between the battery connection interface 200 and the external connection interface 300 is conducted. The external connection interface 300 may also be used for a charging device to be plugged, and thus, the charging device can charge the battery pack when a charging path between the battery connection interface 200 and the external connection interface 300 is conducted.

The discharging driver 400 can be used to control conduction of the discharging path between the battery connection interface 200 and the external connection interface 300. As the discharging driver 400 is electrically connected to the discharging control pin of the processing chip 100, and the discharging driver 400 is electrically connected between the external connection interface 300 and the battery connection interface 200, the discharging control pin of the processing chip 100 transmits a first level signal to the discharging driver 400 when the battery pack needs to be discharged. The discharging driver 400 is realized to be conducted fast to operate according to the first level signal, so that the discharging path between the battery connection interface 200 and the external connection interface 300 is conducted, which makes the battery pack discharge the load rapidly.

The auxiliary driver 500 can be used to amplify a driving current and transmit the amplified driving current to the charging driver 600, so that the charging driver 600 is conducted to operate quickly. The charging driver 600 can be used to control conduction of the charging path between the battery connection interface 200 and the external connection interface 300. As the auxiliary driver 500 is electrically connected to the charging control pin of the processing chip 100 and the external connection interface 300, the charging driver 600 is electrically connected to the auxiliary driver 500, and the charging driver 600 is electrically connected between the external connection interface 300 and the battery connection interface 200, the charging control pin of the processing chip 100 can transmit a second level signal to the auxiliary driver 500 when the battery pack needs to be charged. The auxiliary driver 500 amplifies the second level signal, which is the driving current, and transmits the amplified driving current to the charging driver 600. The charging driver 600 is rapidly conducted to operate according to the amplified driving current, so that the charging path between the battery connection interface 200 and the external connection interface 300 is conducted, which makes the charging device charge the battery pack rapidly. That is, under driving of the amplified driving current, the charging driver 600 conducts a charging path between the battery connection interface and the external connection interface to charge the battery pack.

The battery connection interface 200 is connected to the group of battery pins of the processing chip 100, the battery connection interface 200 is used to be connected to a battery pack, the battery pack includes a number of single cells connected in series, the external connection interface 300 is used to be connected to a load or a charging device, the discharging driver 400 is connected to the discharging control pin of the processing chip 100, the discharging driver 400 is connected between the external connection interface 300 and the battery connection interface 200, the auxiliary driver 500 is connected to the charging control pin of the processing chip 100 and the battery connection interface 200, the auxiliary driver 500 is connected to the charging control pin of the processing chip 100 and the external connection interface 300, the charging driver 600 is connected to the auxiliary driver 500, and the charging driver 600 is connected between the external connection interface 300 and the battery connection interface 200. Thus, fast charging and discharging management of the battery pack can be realized.

A design of the circuit for the battery management system is optimized in the present disclosure, which simplifies the circuit structure, reduces hardware cost, and adopts a single processing chip 100 for control and management. When charging is needed, the charging control pin of the processing chip 100 firstly controls the auxiliary driver 500 to operate, and then drives the charging driver 600 through the auxiliary driver 500, so that the charging driver 600 is quickly conducted to operate and then the charging path between the external connection interface 300 and the battery connection interface 200 is conducted. That is, the charging path between the battery pack and the charging device is conducted to achieve rapid and stable charging of the battery pack. When discharging is needed, the discharging control pin of the processing chip 100 controls the discharging driver 400 to be quickly conducted to operate and then conduct the discharging path between the external connection interface 300 and the battery connection interface 200. That is, the discharging path between the battery pack and the load is conducted to realize fast and stable discharging of the battery pack. Thus, this improves the anti-jamming capability and charging/discharging management reliability of the circuit.

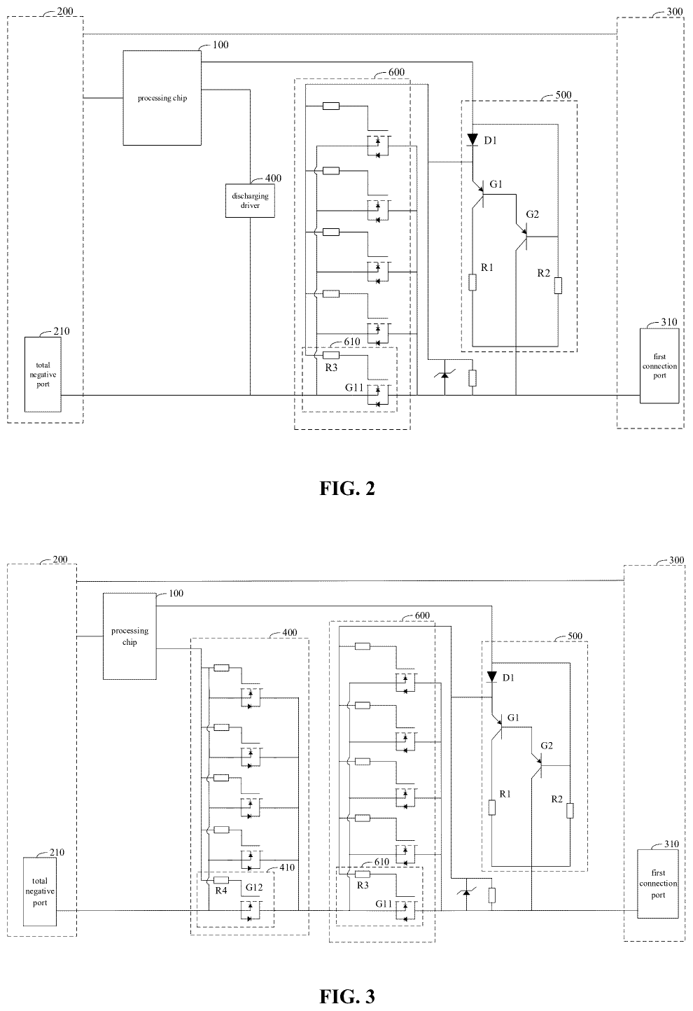

In some embodiments, as shown in FIG. 2, the auxiliary driver module 500 includes a first triode G1, a second triode G2, a first resistor R1, a second resistor R2, and a first diode D1. An anode of the first diode D1 is connected to the charging control pin, and a cathode of the first diode D1 is connected to an emitter of the first triode G1 and the charging driver 600, respectively. A collector of the first triode G1 is connected to a first end of the first resistor R1, and a base of the first triode G1 is connected to an emitter of the second triode G2. A collector of the second triode G2 is connected to the external connection interface 300, a base of the second triode G2 is connected to a first end of the second resistor R2 and the anode of the first diode D1 respectively. A second end of the first resistor R1 and a second end of the second resistor R2 are connected to the external connection interface 300 respectively.

The first triode G1 and the second triode G2 may be PNP-type triodes.

When charging is needed, the charging control pin of the processing chip 100 outputs a second level signal (e.g., a high level signal), and the second level signal is transmitted to the base of the second triode G2, and then the first triode G1 and the second triode G2 are conducted in turn. An amplified driving current is generated after current amplification by the two-stage triode, and the amplified driving current is transmitted to the charging driver 600. That is, the two-stage triode includes the first triode G1 and the second triode G2, and the two-stage triode is configured for amplifying the second level signal and generate the amplified driving current. Then, charging driver 600 is conducted fast to operate according to the amplified driving current, so that the charging path between the battery connection interface 200 and the external connection interface 300 is conducted, thereby realizing that the charging device rapidly charges the battery pack.

In some embodiments, as shown in FIG. 2, the battery connection interface 200 includes a total negative port 210, the external connection interface 300 includes a first connection port 310, and the charging driver 600 includes a plurality of charging sub-drivers 610, and control ends of the charging sub-drivers 610 are connected to the auxiliary driver 500. The charging sub-drivers 610 are connected in parallel between the total negative port 210 and the first connection port 310.

The first connection port 310 is a negative connection port. For example, when the first connection port 310 is connected to a load, the first connection port 310 is a negative connection port of the load, and when the first connection port 310 is connected to a charging device, the first connection port 310 is a negative connection port of the charging device.

The charging driver 600 may include the plurality of charging sub-drivers 610. It should be noted that the number of charging sub-drivers 610 is determined according to the power size of the battery pack, and the larger the number of charging sub-drivers 610 is, the stronger the charging drive energy is.

For example, the charging driver 600 may include six charging sub-drivers 610, the six charging sub-drivers 610 are connected in parallel between the total negative port 210 and the first connection port 310, and the control ends of the charging sub-drivers 610 are electrically connected to the auxiliary driver 500 respectively. Thus, when the battery pack needs to be charged, the charging control pin of the processing chip 100 may transmit a second level signal to the auxiliary driver 500. The auxiliary driver 500 amplifies the driving current according to the second level signal and transmits the amplified driving current to the charging sub-drivers 610, and then the charging sub-drivers 610 are quickly conducted to operate according to the amplified driving current, so that the charging path between the battery connection interface 200 and the external connection interface 300 is conducted, thereby realizing that the charging device quickly charges the battery pack.

In some examples, as shown in FIG. 2, the charging sub-driver 610 includes a first switching tube G11 and a third resistor R3. A first end of the third resistor R3 is connected to the auxiliary driver 500, and a second end of the third resistor R3 is connected to a gate of the first switching tube G1l. A drain of the first switching tube G11 is connected to the total negative port 210, and a source of the first switching tube G11 is connected to the first connection port 310.

The first switching tube G11 may be an N-type MOS tube, and the third resistor R3 is a current-limiting resistor.

For example, when the battery pack needs to be charged, the charging control pin of the processing chip 100 may transmit a second level signal to the auxiliary driver 500. The auxiliary driver 500 amplifies the driving current according to the second level signal, and transmits the amplified driving current through the third resistor R3 of a corresponding charging sub-driver 610 to the gate of the first switching tube G11 of the same charging sub-driver 610. Thus, the gates of the first switching tubes G11 of the charging sub-drivers 610 maintain a high level, and then the first switching tubes G11 of the charging sub-drivers 610 are rapidly conducted. Thus, the charging path between the battery connection interface 200 and the external connection interface 300 is conducted, thereby realizing that the charging device rapidly charges the battery pack.

A single processing chip 100 is used for control and management, and when charging is needed, the charging control pin of the processing chip 100 firstly controls the auxiliary driver 500 to operate, and then drives the charging driver 600 through the auxiliary driver 500. Thus, the charging driver 600 is rapidly conducted to operate, and then the charging path between the external connection interface 300 and the battery connection interface 200 is conducted. That is, the charging path between the battery pack and the charging device is conducted, realizing fast and stable charging of the battery pack. Thus, the design of the circuit for the battery management system is optimized, which simplifies the circuit structure, reduces hardware cost, and improves the anti-interference capability and discharge management reliability of the circuit.

In some embodiments, as shown in FIG. 3, the discharging driver 400 includes a plurality of discharging sub-drivers 410, and a control end of each discharging sub-driver 410 is connected to the discharging control pin, respectively. The discharging sub-drivers 410) are connected in parallel between the total negative port 210 and the charging sub-driver 610.

The discharging driver 400 may include the plurality of discharging sub-drivers 410. It should be noted that the number of discharging sub-drivers 410 is determined according to the power size of the battery pack, and the larger the number of discharging sub-drivers 410 is, the stronger the discharge drive energy.

For example, the discharging driver 400 may include six discharging sub-drivers 410, the six discharging sub-drivers 410 are connected in parallel between the total negative port 210 and the charging sub-driver 610, and the control ends of the discharging sub-drivers 410 are electrically connected to the discharging control pin of the processing chip 100. Thus, when the battery pack needs to be discharged, the discharging control pin of the processing chip 100 may transmit a first level to the discharging sub-drivers 410. The discharging sub-drivers 410 are conducted fast to operate according to the first level, so that the discharging path between the battery connection interface 200 and the external connection interface 300 is conducted, thereby realizing that the battery pack fast discharges the load.

In some embodiments, as shown in FIG. 3, the discharging sub-driver 410 includes a second switching tube G12 and a fourth resistor R4. A first end of the fourth resistor R4 is connected to the discharging control pin, and a second end of the fourth resistor R4 is connected to a gate of the second switching tube G12. A source of the second switching tube G12 is connected to the total negative port 210, and a drain of the second switching tube G12 is connected to the charging sub-driver 610.

The second switching tube G12 may be an N-type MOS tube, and the fourth resistor R4 is a current-limiting resistor.

When the battery pack needs to be discharged, the discharging control pin of the processing chip 100 outputs a first level signal, and through the fourth resistor R4 of a corresponding discharging sub-driver 410, the first level signal is transmitted to the gate of the second switching tube G12 of the same discharging sub-driver 410. The second switching tube G12 is fast conducted according to the first level signal, so that the discharging path between the battery connection interface 200 and the external connection interface 300 is conducted, thereby realizing that the battery pack rapidly discharges the load.

A single processing chip 100 is used for control and management, and when discharging is needed, the discharging control pin of the processing chip 100 controls the discharging driver 400 to be conduct quickly, so that the discharging path between the external connection interface 300 and the battery connection interface 200 is conducted. That is, the discharging path between the battery pack and the load is conducted, thus realizing rapid and stable discharge of the battery pack. Thus, the design of the circuit for the battery management system is optimized, which simplifies the circuit structure, reduces hardware cost, and improves the anti-interference capability and discharge management reliability of the circuit.

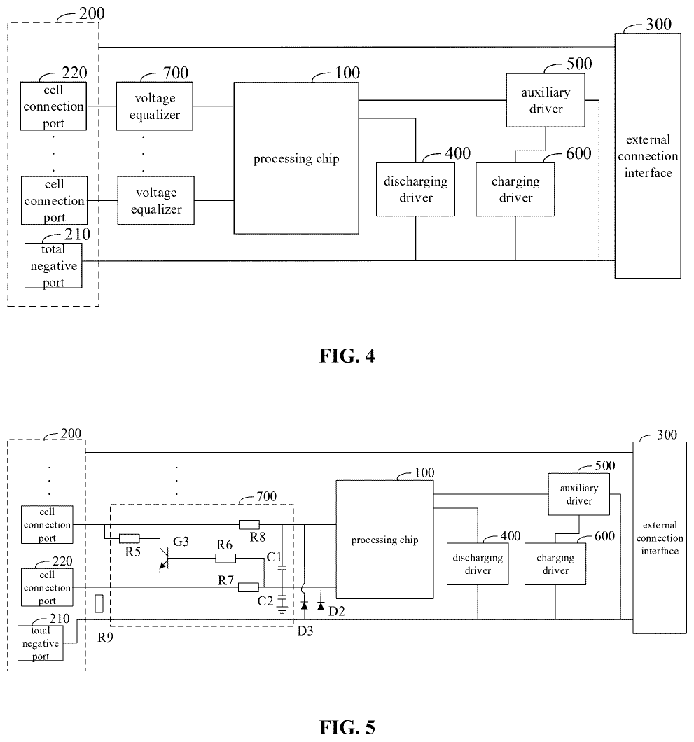

In some embodiments, as shown in FIG. 4, the circuit for the battery management system further includes a plurality of voltage equalizers 700, the group of battery pins includes a plurality of battery pins, and the battery connection interface 200 includes a plurality of cell connection ports 220. The first ends of the voltage equalizers 700 are connected to the battery pins in one-to-one correspondence, and the second ends of the voltage equalizers 700 are connected to the cell connection ports 220 in one-to-one correspondence.

The number of voltage equalizers 700 is determined according to the number of the cell connection ports 220. For example, if the battery connection interface 200 includes 16 cell connection ports 220, the number of voltage equalizers 700 is 16. Each voltage equalizer 700 can be used to equalize and regulate charging and discharging voltages of a single cell. The group of battery pins may include 17 battery pins (e.g., pin VC0 to pin VC16). The battery connection interface 200 may include 17 cell connection ports 220 (e.g., B0 to B16), and the battery connection interface 200 may be plugged with 6 to 16 single cells connected in series.

As the first ends of the voltage equalizers 700 are electrically connected to the battery pins in one-to-one correspondence, and the second ends of the voltage equalizers 700 are electrically connected to the cell connection ports 220 in one-to-one correspondence, the adjacent 2 battery pins of the processing chip 100 may detect a voltage of the corresponding single cell in real time. When it is detected that the voltage of the corresponding single cell reaches an equalization condition (e.g., when the voltage is greater than a predetermined threshold), the processing chip 100 transmits an equalization drive signal to the corresponding voltage equalizer 700 through the corresponding battery pin, and then the corresponding voltage equalizer 700 is conducted to operate. Thus, the voltage equalizer 700 forms an external equalization discharge loop with the corresponding single cell, and controls the discharge of the corresponding single cell, so that the voltages of the various single cells of the battery pack are equalized.

In some embodiments, as shown in FIG. 5, the equalization module 700 includes a third triode G3, a fifth resistor R5, a sixth resistor R6, a seventh resistor R7, an eighth resistor R8, a first capacitance C1, and a second capacitance C2. A collector of the third triode G3 is connected to a first end of the fifth resistor R5, an emitter of the third triode G3 is connected to the cell connection port 220 corresponding to the negative pole of the same single cell, and a base of the third triode G3 is connected to the first end of the sixth resistor R6. The second end of the sixth resistor R6 is connected to the second end of the seventh resistor R7, the second end of the seventh resistor R7 is further connected to the battery pin corresponding to the negative pole of the same single cell, and the first end of the seventh resistor R7 is connected to the emitter of the third triode G3. The second end of the fifth resistor R5 is connected to the cell connection port 220 corresponding to the positive pole of the same single cell, the first end of the eighth resistor R8 is connected to the second end of the fifth resistor R5, and the second end of the eighth resistor R8 is connected to the battery pin corresponding to the positive pole of the same single cell. The first capacitor C1 is connected between the second end of the eighth resistor R8 and the second end of the seventh resistor R7. The second capacitor C2 is connected between the second end of the seventh resistor R7 and a ground.

The third transistor G3 may be an NPN transistor. The eighth resistor R8 and the first capacitor C1 form a filtering circuit. The fifth resistor R5 is a discharging load resistor. The sixth resistor R6 is a current-limiting resistor, and the seventh resistor R7 and the second capacitor C2 form another filtering circuit.

Exemplarily; the negative pole of the single cell is connected to the cell connection port B0, and the positive pole of the single cell is connected to the cell connection port B1. The battery pin VC0 of the processing chip 100 detects the voltage of the cell connection port B0, and the battery pin VC1 of the processing chip 100 detects the voltage of the cell connection port B1. The voltage of the corresponding single cell is then determined according to a voltage difference between voltages of the battery pin VC0 and the battery pin VC1 of the processing chip 100. When the voltage of the corresponding single cell is detected to reach the equalization condition (such as when the voltage is greater than a preset threshold), the processing chip 100 outputs an equalization drive signal through the battery pin VC0, the equalization drive signal is transmitted to the base of the third transistor G3 through the sixth resistor R6, and then the third transistor G3 is conducted. Thus, an external equalization discharge loop is formed among the third transistor G3, the fifth resistor R5, and the corresponding single cell, and the corresponding single cell is controlled to discharge, so as to equalize the voltage of each single cell of the battery pack.

In some embodiments, as shown in FIG. 5, the circuit for battery management system further includes a second diode D2, a third diode D3, and a ninth resistor R9. The first end of the ninth resistor R9 is connected to a cell connection port corresponding to the negative pole of a first single cell, and the second end of the ninth resistor R9 is connected to the total negative port 210. The first single cell is a single cell adjacent to and connected to the total negative port 210. The cathode of the second diode D2 is connected to a battery pin corresponding to the negative pole of the first single cell, and the anode of the second diode D2 is connected to the total negative port 210. The cathode of the third diode D3 is connected to a battery pin corresponding to the positive pole of the first single cell, and the anode of the third diode D3 is connected to the total negative port 210.

The second diode D2 and the third diode D3 are Schottky diodes. The first single cell refers to a single cell connected between the cell connection port B1 and the cell connection port B0. That is, the negative pole of the first single cell is a total negative pole of the battery pack.

As the cathode of the second diode D2 is connected to the battery pin corresponding to the negative pole of the first single cell, the anode of the second diode D2 is connected to the total negative port 210, the cathode of the third diode D3 is connected to the battery pin corresponding to the positive pole of the first single cell, and the anode of the third diode D3 is connected to the total negative port 210, the anti-messy power up and down capability can be improved.

As the first end of the ninth resistor R9 is connected to the cell connection port corresponding to the negative pole of the first single cell, and the second end of the ninth resistor R9 is connected to the total negative port 210, the impact of current interference on the lowest voltage acquisition accuracy is reduced, and the chaotic power-up requirement of the single cell can be supported at the same time during high-current charging and discharging.

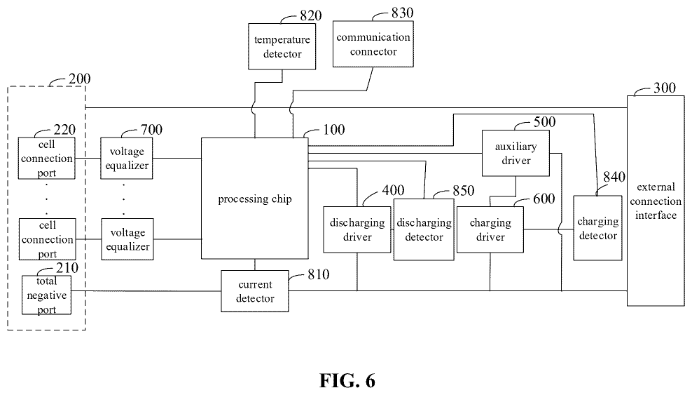

In some embodiments, as shown in FIG. 6, the circuit for the battery management system further includes a current detector 810 and a temperature detector 820. The processing chip 100 further includes temperature detection pins and current detection pins. The temperature detection pins are connected to the temperature detector 820, and the temperature detector 820 is used to be connected to a temperature sensing probe. The battery detection pins are connected to the current detector 810, and the current detector 810 is connected between the external connection interface 300 and the battery connection interface 200.

The current detection pins of the processing chip 100 are used to collect charging and discharging currents of the battery pack. For example, the current detection pins of the processing chip 100 are pin RS1 and pin RS2, and the current detector 810 may include filtering capacitors, such as a first filtering capacitor connected between the pin RS1 and the ground, a second filtering capacitor connected between the pin RS2 and the ground, and a third filtering capacitor connected between pin RS1 and pin RS2, in which the first filtering capacitor and the second filtering capacitor are of the same type. Exemplarily; the current detector 810 may include filtering resistors, such as a first filtering resistor connected to pin RS1 and a second filtering resistor connected to the pin RS2. The current detector 810 also includes a plurality of sampling resistors. The sampling resistors are connected in parallel between the pins RS1 and the pins RS2 of the processing chip 100. For example, the number of sampling resistors may be five.

The temperature detection pins of the processing chip 100 may be used to detect charging and discharging temperatures of the battery pack. For example, the temperature detection pins of the processing chip 100 may be pins TS1 to pin TS3. The pin TS1 is externally connected to a resistor connected in parallel with a capacitor, the pin TS2 is externally connected to a resistor connected in parallel with a capacitor, and the pin TS3 is externally connected to a resistor connected in parallel with a capacitor. The temperature detector 820 may include a temperature detection interface. A temperature sensing probe may be inserted in the temperature detection interface. The temperature detection pins are connected to the temperature detector 820, and the temperature detector 820 is used to be connected to the temperature sensing probe. Three-path temperature detection may be realized through the temperature sensing probe, which can be realized as charging high-temperature, charging low-temperature, discharging high-temperature, and discharging low-temperature of a single cell. For example, the pin TS3 can be used to detect both the temperature of the single cell and the temperature of the discharging driver 400. As a circuit current is detected in real time by the current detector 810, and a temperature is detected in real time by the temperature detector 820, a corresponding protection function is played based on the current data and the temperature data, improving the safety performance of the system.

In some embodiments, as shown in FIG. 6, the circuit for the battery management system also includes a communication connector 830. The processing chip 100 also includes communication pins, the communication pins are connected to the communication connector 830, and the communication connector 830 is used to plug in a terminal device.

The communication pins of the processing chip 100 may be a pin RXD and a pin TXD. The communication connector 830 may be used to plug in a terminal device, for example, the terminal device may be a computer or a cellular phone. The communication connector 830 may be a serial communication connector 830. For example, the communication connector 830 is provided with a USB interface, and the terminal device is plugged in to the USB interface of the communication connector 830 through a USB cable, thereby realizing a communication connection between the terminal device and the processing chip 100, so that the terminal device can read relevant parameters of a processing device including the processing chip 100, realizing the diversification of functions for the battery management system, improving the practicability; and satisfying most application scenes.

In some embodiments, as shown in FIG. 6, the circuit for the battery management system further includes a charging detector 840 and a discharging detector 850. The processing chip 100 further includes a charging detection pin and a discharge detection pin. The charging detection pin is connected to the charging detector 840, which is connected to the charging driver 600. The discharge detection pin is connected to the discharging detector 850, which is connected to the discharging driver 400.

The charging detection pin of the processing chip 100 may be a pin CHGD, and the discharge detection pin of the processing chip 100 may be a pin DSGD.

For example, the charging detector 840 may include a charging detection resistor, a first end of the charging detection resistor is connected to the processing chip 100, and a second end of the charging detection resistor is connected to the charging driver 600. Thus, when it is to detect the charging device, the processing chip 100 turns on a pull-up current source inside the pin CHGD, and when the pin CHGD of the processing chip 100 detects that a voltage is less than a first preset value, the charging device is determined to be connected for charging, and when the pin CHGD of the processing chip 100 detects that the voltage is greater than the first preset value, the charging device is determined to be disconnected for charging.

The discharging detector 850 may include a discharge detection resistor, a first end of the discharge detection resistor is connected to the processing chip 100, and a second end of the discharge detection resistor is connected to the discharging driver 400. When the load needs to be detected, the processing chip 100 opens a pull-down resistor inside the pin DSGD, and when the pin DSGD of the processing chip 100 detects that a voltage is greater than a second preset value, the load is determined to connected for discharging, and when the pin DSGD of the processing chip 100 detects that the voltage is less than the second preset value, the load is determined to be disconnected for discharging. Thus, the charging and discharging detection of the battery pack is realized.

In some examples, the battery pack may include 16 single cells connected in series, and the battery connection interface 200 includes cell connection ports 220, i.e., B0 to B16, of which the cell connection port B0 is connected to the negative pole of a first single cell, the cell connection port B1 is connected to the positive pole of the first single cell, the cell connection port B2 is connected to the positive pole of a second single cell, the cell connection port B1 is connected to the negative pole of the second single cell and so on.

When compatibility with different number of strings is needed, B16 needs to be shorted towards B15 to B6. For example, when 16 series-connected single cells are reconfigured as 13 strings, the cell connection port B13, the cell connection port B14, the cell connection port B15, the cell connection port B16 are shorted, and at the same time the corresponding first capacitance C1 and the second capacitance C2 are shorted. Thus, the number of strings of single cells can be adjusted arbitrarily between 6 and 16, and is compatible with many usage scenarios.

In some embodiments, there is also provided a battery system including a battery pack and a circuit for battery management system (BMS) as described in any one of the embodiments.

The battery pack may include 16 single cells connected in series. The single cells may, but are not limited to, ternary or lithium iron cells.

The processing chip includes a group of battery pins, a discharging control pin, and a charging control pin. The battery connection interface is connected to the group of battery pins, and the battery connection interface is used to be connected to a battery pack, and the battery pack includes a plurality of single cells which are series-connected. The external connection interface is used to be connected to an external device. The discharging driver is connected to the discharging control pin. The discharging driver is connected to between the external connection interface and the battery connection interface. The auxiliary driver is connected to the charging control pin and the external connection interface, respectively. The charging driver is connected to the auxiliary driver. The charging driver is connected between the external connection interface and the battery connection interface. Thus, fast charging and discharging management of the battery pack can be realized. A design of the circuit for the battery management system is optimized in the present disclosure, which simplifies the circuit structure, reduces hardware cost, and adopts a single processing chip for control and management. When charging is needed, the charging control pin of the processing chip firstly controls the auxiliary driver to operate, and then drives the charging driver through the auxiliary driver, so that the charging driver is quickly conducted to operate and then the charging path between the external connection interface and the battery connection interface is conducted. That is, the charging path between the battery pack and the charging device is conducted to achieve rapid and stable charging of the battery pack. When discharging is needed, the discharging control pin of the processing chip controls the discharging driver to be quickly conducted to operate and then conduct the discharging path between the external connection interface and the battery connection interface. That is, the discharging path between the battery pack and the load is conducted to realize fast and stable discharging of the battery pack. Thus, this improves the anti-jamming capability and charging/discharging management reliability of the circuit.

It is noted that the battery system may also include components such as a case. Specifically, the battery system may include more components than described in the above embodiments, or combine certain components, or have different component arrangements.

What is claimed is:

1. A circuit for battery management system (BMS), comprising:
a processing chip;
a battery connection interface, connected to the processing chip and a battery pack;
an external connection interface, connected to an external device;
a discharging driver, connected to the processing chip, the external connection interface, and the battery connection interface;
an auxiliary driver, connected to the processing chip and the external connection interface; and
a charging driver, connected to the auxiliary driver, the external connection interface, and the battery connection interface;
wherein the processing chip is configured for controlling the auxiliary driver to amplify a driving current and transmit an amplified driving current to the charging driver, in response to the battery pack requiring being charged;
the charging driver is configured for conducting a charging path between the battery connection interface and the external connection interface to charge the battery pack, under driving of the amplified driving current;
the processing chip is further configured for controlling the discharging driver to conduct a discharging path between the battery connection interface and the external connection interface to discharge the external device, in response to the battery pack requiring being discharged.

2. The circuit for BMS of claim 1, wherein the processing chip comprises:
a discharging control pin, connected to the discharging driver and configured for outputting a first level signal to control the discharging driver to be conducted; and
and a charging control pin, connected to the auxiliary driver and configured for outputting a second level signal to the auxiliary driver, the second level signal being the driving current.

3. The circuit for BMS of claim 2, wherein the auxiliary driver comprises:
a two-stage triode, configured for amplifying the second level signal and generate the amplified driving current.

4. The circuit for BMS of claim 3, wherein the two-stage triode comprises a first triode and a second triode;
the auxiliary driver further comprises a first resistor, a second resistor, and a first diode;
wherein an anode of the first diode is connected to the charging control pin, a cathode of the first diode is connected to an emitter of the first triode and the charging driver, respectively, a collector of the first triode is connected to a first end of the first resistor, a base of the first triode is connected to an emitter of the second triode, a collector of the second triode is connected to the external connection interface, a base of the second triode is connected to a first end of the second resistor and the anode of the first diode respectively, and a second end of the first resistor and a second end of the second resistor are connected to the external connection interface, respectively.

5. The circuit for BMS of claim 1, wherein the charging driver comprises a plurality of charging sub-drivers, and each of the charging sub-drivers comprises a first switching tube, configured for being conducted under the amplified driving current.

6. The circuit for BMS of claim 5, wherein the each of the charging sub-drivers further comprises a third resistor;
the battery connection interface comprises a total negative port, and the external connection interface comprises a first connection port;
wherein a first end of the third resistor is connected to the auxiliary driver, a second end of the third resistor is connected to a gate of the first switching tube, a drain of the first switching tube is connected to the total negative port, and a source of the first switching tube is connected to the first connection port.

7. The circuit for BMS of claim 1, wherein the discharging driver comprises a plurality of discharging sub-drivers, and each of the discharging sub-drivers comprises a second switching tube, configured for being conducted under the first level signal.

8. The circuit for BMS of claim 7, wherein the each of the discharging sub-drivers further comprises a fourth resistor;
the battery connection interface comprises a total negative port;
wherein a first end of the fourth resistor is connected to the discharging control pin, a second end of the fourth resistor is connected to a gate of the second switching tube, a source of the second switching tube is connected to the total negative port, and a drain of the second switching tube is connected to the charging driver.

9. The circuit for BMS of claim 1, wherein the battery connection interface comprises a total negative port, the external connection interface comprises a first connection port, and the charging driver comprises a plurality of charging sub-drivers;
control ends of the charging sub-drivers are connected to the auxiliary driver, and the charging sub-drivers are connected in parallel between the total negative port and the first connection port.

10. The circuit for BMS of claim 9, wherein the discharging driver comprises a plurality of discharging sub-drivers, and control ends of the discharging sub-drivers are connected to the discharging control pin;
the discharging sub-drivers are connected in parallel between the total negative port and the charging sub-drivers.

11. The circuit for BMS of claim 9, further comprising a plurality of voltage equalizers;
wherein the processing chip comprises a group of battery pins, the group of battery pins comprises a plurality of battery pins, and the battery connection interface comprises a plurality of cell connection ports;
first ends of the voltage equalizers are connected to the battery pins in one-to-one correspondence, and second ends of the voltage equalizers are connected to the cell connection ports in one-to-one correspondence.

12. The circuit for BMS of claim 11, wherein each of the voltage equalizers comprises a third triode, a fifth resistor, a sixth resistor, a seventh resistor, an eighth resistor, a first capacitance, and a second capacitance;
a collector of the third triode is connected to a first end of the fifth resistor, an emitter of the third triode is connected to a cell connection port corresponding to a negative pole of a same single cell, and a base of the third triode is connected to a first end of the sixth resistor;
a second end of the sixth resistor is connected to a second end of the seventh resistor,
the second end of the seventh resistor is further connected to a battery pin corresponding to the negative pole of the same single cell, and a first end of the seventh resistor is connected to the emitter of the third triode;
a second end of the fifth resistor is connected to a cell connection port corresponding to the positive pole of the same single cell,
a first end of the eighth resistor is connected to the second end of the fifth resistor, and a second end of the eighth resistor is connected to a battery pin corresponding to the positive pole of the same single cell;
the first capacitor is connected between the second end of the eighth resistor and the second end of the seventh resistor;
the second capacitor is connected between the second end of the seventh resistor and a ground.

13. The circuit for BMS of claim 12, further comprising a second diode, a third diode, and a ninth resistor;
wherein a first end of the ninth resistor is connected to a cell connection port corresponding to a negative pole of a first single cell, and a second end of the ninth resistor is connected to the total negative port, wherein the first single cell is a single cell adjacent to and connected to the total negative port;
a cathode of the second diode is connected to a battery pin corresponding to the negative pole of the first single cell, and an anode of the second diode is connected to the total negative port;
a cathode of the third diode is connected to a battery pin corresponding to a positive pole of the first single cell, and an anode of the third diode is connected to the total negative port.

14. The circuit for BMS of claim 1, further comprising a current detector and a temperature detector;
wherein the processing chip further comprises temperature detection pins and current detection pins;
the temperature detection pins are connected to the temperature detector, and the temperature detector is configured for being connected to a temperature sensing probe;
the battery detection pins are connected to the current detector, and the current detector is connected between the external connection interface and the battery connection interface.

15. The circuit for BMS of claim 1, further comprising a communication connector;
wherein the processing chip further comprises communication pins;
the communication pins are connected to the communication connector, and the communication connector is configured for plugging in a terminal device.

16. The circuit for BMS of claim 1, further comprising a charging detector and a discharging detector;
wherein the processing chip further includes a charging detection pin and a discharge detection pin;
the charging detection pin is connected to the charging detector, and the charging detector is further connected to the charging driver;
the discharge detection pin is connected to the discharging detector, and the discharging detector is further connected to the discharging driver.

17. A battery system, comprising a battery pack; and
a circuit for battery management system (BMS), comprising:
a processing chip;
a battery connection interface, connected to the processing chip and the battery pack;
an external connection interface, connected to an external device;
a discharging driver, connected to the processing chip, the external connection interface, and the battery connection interface;
an auxiliary driver, connected to the processing chip and the external connection interface; and
a charging driver, connected to the auxiliary driver, the external connection interface, and the battery connection interface;
wherein the processing chip is configured for controlling the auxiliary driver to amplify a driving current and transmit an amplified driving current to the charging driver, in response to the battery pack requiring being charged;
the charging driver is configured for conducting a charging path between the battery connection interface and the external connection interface to charge the battery pack, under driving of the amplified driving current;
the processing chip is further configured for controlling the discharging driver to conduct a discharging path between the battery connection interface and the external connection interface to discharge the external device, in response to the battery pack requiring being discharged.

18. A circuit for battery management system (BMS), comprising;
a processing chip;
a battery connection interface, connected to the processing chip and a battery pack;
an external connection interface, connected to an external device;
a discharging driver, connected to between the external connection interface and the battery connection interface and further connected to the processing chip;
a charging driver, connected to between the external connection interface and the battery connection interface; and
an auxiliary driver, connected to the charging driver and the processing chip; and
wherein the processing chip is configured for outputting a first level signal to control the discharging driver to be conducted such that a discharging path between external connection interface and the battery connection interface is conducted, in response to the battery pack being discharged, and the processing chip is further configured for outputting a second level signal to control the auxiliary driver and charging driver to be conducted such that a charging path between external connection interface and the battery connection interface is conducted, in response to the battery pack being charged.

19. The circuit for BMS of claim 18, wherein the auxiliary driver comprises a first triode and a second triode, a first resistor, a second resistor, and a first diode;
wherein an anode of the first diode is connected to the charging control pin, a cathode of the first diode is connected to an emitter of the first triode and the charging driver, respectively, a collector of the first triode is connected to a first end of the first resistor, a base of the first triode is connected to an emitter of the second triode, a collector of the second triode is connected to the external connection interface, a base of the second triode is connected to a first end of the second resistor and the anode of the first diode respectively, and a second end of the first resistor and a second end of the second resistor are connected to the external connection interface, respectively.

20. The circuit for BMS of claim 18, wherein the charging driver comprises a first switching tube, configured for being conducted in response to the auxiliary driver being conducted under the second level signal;
the discharging driver comprises a second switching tube, configured for being conducted under the first level signal.
